(19) United States
(12) Patent Application Publication
(10) Pub. No.: US 2014/0071854 A1
(43) Pub. Date: Mar. 13, 2014

(54) System and Methods for Dual Mode Network Selection

(71) Applicant: FutureWei Technologies, Inc., Plano, TX (US)

(72) Inventors: Zhixian Xiang, Plano, TX (US); Kaidi Huang, Chengdu (CN); Weisheng Jin, Shenzhen (CN); Wenruo Zhu, Shanghai (CN); Youyang Yu, Shanghai (CN)

(21) Appl. No.: 14/026,846

(22) Filed: Sep. 13, 2013

Related U.S. Application Data
(60) Provisional application No. 61/700,571, filed on Sep. 13, 2012.

(51) Int. Cl. H04W 48/16

(52) U.S. Cl. CPC H04W 48/16
USPC 370/254

(57) ABSTRACT

Embodiments are provided for supporting network selection for dual mode user equipment that access both WiFi and 3GPP networks. The embodiments allow a UE to determine network selection for a WLAN using an Access Network Discovery and Selection Function (ANDSF) according to the UE's capability to support a HotSpot 2.0 (HS2.0) WiFi selection mechanism. In an embodiment, the ANDSF server provides the UE with network selection policy and discovery information indicating available wireless access networks to the UE. The information provided to the UE includes both information for HS2.0 capable UEs and information for non-HS2.0 capable UEs. The UE then selects the suitable information for network selection according to UE support or lack thereof for HS2.0. In another embodiment, the ANDSF receives capability information from the UE regarding support for HS2.0, and accordingly provides suitable selection policy and network discovery information to the UE.

This application claims the benefit of U.S. Provisional Application No. 61/700,571 filed on Sep. 13, 2012 by Zhixian Xiang et al. and entitled “System and Method for Dual Mode Network Selection,” which is hereby incorporated herein by reference as if reproduced in its entirety.

### TECHNICAL FIELD

The present invention relates to the field of wireless communications, and, in particular embodiments, to a system and method for a system and methods for Dual Mode network selection.

### BACKGROUND

WiFi is becoming an important component of cellular operators to help them meet the market demand and increase their competition edge. Cellular operators are motivated to integrate WiFi access into their existing cellular networks, and many current mobile devices have dual mode (WiFi and cellular) capability. 3GPP also defines several mechanisms for mobile device to decide and select the wireless local area network (WLAN), such as via policies that may be statically pre-configured by the operator on the UE, or dynamically set by the operator via an Access Network Discovery and Selection Function (ANDSF) within the network. Hotspot 2.0 (HS2.0) is a new WiFi selection mechanism defined by the WiFi Alliance (WFA). Although current 3GPP supports WiFi, there exist technical gaps for 3GPP to support a HS2.0 terminal for smart network selection. In the current 3GPP and WFA HS2.0 specifications, there is no clear definition on the procedure of how a dual mode (3GPP/WiFi) terminal conducts network selection for a WiFi network, such as on the relationship between public land mobile network (PLMN) selection and ANDSF selection. WLAN (or WiFi network) discovery and selection mechanisms are needed for dual mode HS2.0 terminals/mobile devices.

### SUMMARY OF THE INVENTION

In accordance with an embodiment, a method implemented by a network component for enabling user equipment (UE) network selection includes receiving, at an Access Network Discovery and Selection Function (ANDSF), an ANDSF query from a UE. The ANDSAF query includes capability information regarding network selection and network access technology for the UE. The method further includes generating, at the ANDSF, network selection policy and network discovery information in accordance with the capability information. The network discovery information indicates available wireless networks for the UE. The network component then sends, to the UE, the network discovery information indicating available wireless networks for the UE, and upon determining that the UE does not support the defined network selection mechanism, additional network selection policy or network discovery information.

In accordance with another embodiment, a method implemented by a network component for enabling UE network selection includes generating, using an ANDSF, network selection policy and network discovery information indicating available wireless networks for UEs with capability to support a defined network selection mechanism, and generating, using the ANDSF, additional network selection policy and network discovery information for UEs without capability to support the defined network selection mechanism. The method further includes sending, to a UE, both the network selection policy and network discovery information for UEs with capability to support a defined network selection mechanism, and the additional network selection policy and network discovery information for UEs without capability to support the defined network selection mechanism.

In accordance with another embodiment, a method implemented by a UE for network selection includes sending, to an ANDSF server, an ANDSF query indicating UE capability information regarding network selection and network access technology for the UE, and receiving, from the ANDSF server, network selection policy and network discovery information indicating available wireless local area networks (WLANs) for the UE in accordance with the capability information from the UE. The method further includes sending, to a WLAN, an Access Network Query Protocol (ANQP) query for additional network selection policy upon determining that the UE supports the defined network selection mechanism.

In accordance with another embodiment, a method implemented by a UE for network selection includes receiving, from the ANDSF server, network selection policy and network discovery information indicating available wireless networks for UEs with capability to support a defined network selection mechanism, and further receiving, from the ANDSF server, additional network selection policy and network discovery information for UEs without capability to support the defined network selection mechanism. Upon determining that the UE supports the defined network selection mechanism, a wireless access network is selected by the UE using the network selection policy and network discovery information for UEs with capability to support a defined network selection mechanism. Alternatively, upon determining that the UE does not support the defined network selection mechanism, the wireless access network is selected using the additional network selection policy and network discovery information for UEs without capability to support the defined network selection mechanism.

In accordance with another embodiment, a network component for enabling UE network selection includes at least one processor and a non-transitory computer readable storage medium storing programming for execution by the at least one processor. The programming including instructions to receive, at an ANDSF, an ANDSF query from a UE. The ANDSAF query includes capability information regarding network selection and network access technology for the UE. The programming includes further instructions to generate, at the ANDSF, network selection policy and network discovery information in accordance with the capability information. The network discovery information indicating available wireless networks for the UE. The network component is also configured to send, to the UE, the network discovery information indicating available wireless networks for the UE, and upon determining that the UE does not support the defined network selection mechanism, additional network selection policy or network discovery information.

In accordance with another embodiment, a network component for enabling UE network selection includes at least one processor and a non-transitory computer readable storage medium storing programming for execution by the at least one processor. The programming including instructions to generate, using an ANDSF, network selection policy and network discovery information indicating available wireless networks for UEs with capability to support a defined network selection mechanism, and further generating additional network selection policy and network discovery information for UEs without capability to support the defined network selection mechanism. The network component is also configured to send, to a UE, both the network selection policy and network discovery information for UEs with capability to support a defined network selection mechanism, and the additional network selection policy and network discovery information for UEs without capability to support the defined network selection mechanism.

In accordance with another embodiment, a UE configured for network selection for wireless network access includes at least one processor and a non-transitory computer readable storage medium storing programming for execution by the at least one processor. The programming including instructions to send, to an ANDSF server, an ANDSF query indicating UE capability information regarding network selection and network access technology for the UE, and receive, from the ANDSF server, network selection policy and network discovery information indicating available wireless local area networks (WLANs) for the UE in accordance with the capability information from the UE. The UE is further configured to send, to a WLAN, an Access Network Query Protocol (ANQP) query for additional network selection policy upon determining that the UE supports the defined network selection mechanism.

In accordance with yet another embodiment, a UE configured for network selection for wireless network access includes at least one processor and a non-transitory computer readable storage medium storing programming for execution by the at least one processor. The programming includes instructions to receive, from the ANDSF server, network selection policy and network discovery information indicating available wireless networks for UEs with capability to support a defined network selection mechanism. The programming includes further instructions to receive, from the ANDSF server, additional network selection policy and network discovery information for UEs without capability to support the defined network selection mechanism. Upon determining that the UE supports the defined network selection mechanism, the UE selects a wireless access network using the network selection policy and network discovery information for UEs with capability to support a defined network selection mechanism. Alternatively, upon determining that the UE does not support the defined network selection mechanism, the UE selects a wireless access network using the additional network selection policy and network discovery information for UEs without capability to support the defined network selection mechanism.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a system for network selection policy via ANDSF;

FIG. 2 illustrates an embodiment method for obtaining network selection policy via ANDSF for HS2.0 devices;

FIG. 3 illustrates an embodiment method for network selection for HS2.0 devices;

FIG. 4 illustrates an embodiment scheme for obtaining network selection policy based on user equipment (UE) capability for HS2.0 devices via ANDSF;

FIG. 5 illustrates an embodiment method by a UE for enabling network selection for HS2.0 devices;

FIG. 6 illustrates an embodiment method by a network or network component for enabling network selection for HS2.0 devices;

FIG. 7 is a diagram of an exemplary processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments are provided for supporting network selection for dual mode HotSpot 2.0 (HS2.0) devices that access both WiFi and 3GPP networks. The embodiments allow a HS2.0 UE to determine network selection for a WLAN using an Access Network Discovery and Selection Function (ANDSF), which provides the HS2.0 network selection policies. Additionally, an Access Network Query Protocol (ANQP) can be used to add network information to the discovery information of the ANDSF. An Organizationally Unique Identifier (OUI) concept is also added enabling the UE to prioritize and group candidate WLANs or WiFi access points (APs) for the network selection process. The terms WiFi network and WLAN are used herein interchangeably to indicate WLANs based on the Institute of Electrical and Electronics Engineers (IEEE) 802.11 standards. The UE may also provide its capability information to the ANDSF. The UE capability information is used by the ANDSF to provide the UE relevant policy and network information.

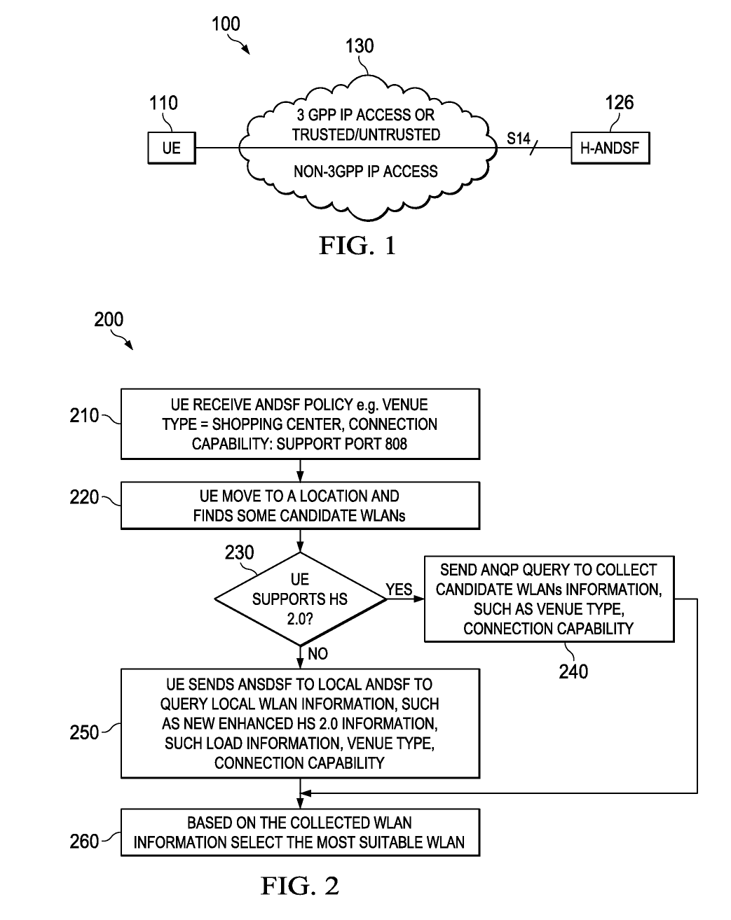

FIG. 1 illustrates a system 100 for network selection policy via an ANDSF. A UE 110 interacts with an ANDSF server 120 through S14 interface which is Internet Protocol (IP) level signaling to get network selection policy from a network. The UE is a dual mode device that supports operating both 3GPP and WiFi technologies, either simultaneously or one technology at a time. The UE 110 may also support HS2.0 mechanisms for WiFi selection. The UE 110 can access the ANDSF server 120 via an IP network 130, e.g., via 3GPP IP access or via trusted/untrusted non-3GPP IP access. Through the IP network 130, the UE 110 interacts with the ANDSF server 120 using the S14 interface. The ANDSF server 120 may populate the policy to the UE 110 in one of two ways. Using a push mode, the ANDSF server 120 pushes the policy information to the UE 110. Alternatively, using a pull mode, the UE requests the policy information from the ANDSF server 120.

The policy information provided by the ANDSF server 120 to the UE 110 helps the UE 110 perform WiFi network or WLAN selection. This information includes inter-system routing policy, such as validity conditions indicating when the provided policy is valid. The information can also include one or more filter rules, each identifying a prioritised list of access technologies/access networks to be used by the UE 110 when available for routing traffic that matches specific IP filters on a designated Access Point Name (APN) or on any APN. A filter rule can also identify which radio access technologies are restricted for traffic that matches specific IP filters on a specific APN or on any APN. For example, a WLAN is not allowed for Real-time Transport Protocol (RTP)/RTP Control Protocol (RTCP) traffic flows on APN-x.

In one implementation, the ANDSF server 120 may provide the UE 110 with WiFi network information that are typically available by ANQP query to 802.11u/HS2.0 capable UEs. The UE 110 can provide indication to the network or ANDSF server 120 to query the ANDSF server 120 for this information without using ANQP. The indication may be in the form of an indicator, such a fast network discovery indicator. The ANDSF server 120 may also provide the UE 110 static and semi-static network parameters, including at least one of OUI information (e.g., an OUI for each available WLAN or WiFi network), 3GPP cellular network information, a domain name list, connection capability, venue name information, operating class indication, and possibly other information. The information provided by the ANDSF server 120 to the UE 110 may be bound with service set identification (SSID)/basic SSID (BSSID). In another implementation, to reduce network traffic, a HS2.0 capable UE 110 obtains local WLAN information through ANQP query if the WLANs support 802.11u standard with limited information through ANDSF network information update.

FIG. 2 illustrates an embodiment method 200 for obtaining network selection policy as well as network discovery information via ANDSF for HS2.0 devices. For example, the method 200 can be implemented by the UE 110. At step 210, the UE receives ANDSF policy and network discovery information, such as venu type (e.g., venu type=shopping center) and connection capability (e.g., support port 808). At step 220, the UE moves to a location and finds one or more candidate WLANs for the location. At decision step 230, the method 200 either moves to step 240 if the UE supports HS2.0 or to step 250 if the UE does not support HS2.0. At step 240, the UE sends ANQP query (to the WLANs) to collect WLANs information, such as venu type and connection capability. Alternatively, at step 250, the UE sends ANDSF request to a local ANDSF server (e.g., in a local WLAN) to query local WLAN information, such as new enhanced HS2.0 information, venu type, and connection capability. The method 200 proceeds to step 260 after step 240 or 250. At step 260, the UE selects a suitable or most suitable WLAN based on the collected WLAN information.

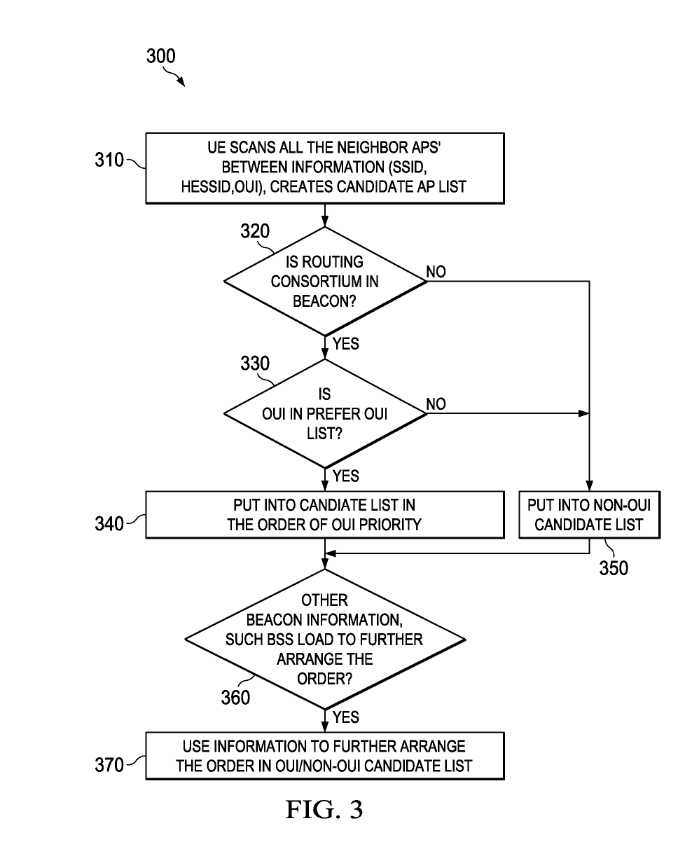

As described above, the information provided to the UE by the ANDSF may include an OUI (e.g., defined by IEEE) for each available WLAN at the location of the UE. Operators may register or may be assigned corresponding OUIs. The UE uses the OUI to prioritize and/or group candidate WLANs (or APs), for instance based on an OUI prefer list (a roaming consortium list). The UE can then use the prioritized/grouped candidate WLANs in PLMN selection via ANQP query. As such, the UE can create an OUI based PLMN prefer roaming list. FIG. 3 an embodiment method 300 for network selection for HS2.0 devices using OUI. At step 310, The UE scans the neighbor APs' beacon information (e.g., SSID, Homogeneous Extended SSID (HESSID), OUI), and creates a candidate AP list. At decision step 320, the UE determines whether there is a routing consortium in the beacon information. If the condition in step 320 is satisfied, then at step 330 the UE determines whether the OUI (for each WLAN or AP) is in a prefer OUI list previously obtained from an ANDSF server as part of network selction policy an discovery information. If the OUI is in the prefer OUI list, then at step 340 the UE puts the OUI into the candidate list in the order of the OUI priority. Alternatively, if the condition in step 320 or 330 is not satisfied, then at step 350, the UE puts the OUI in a non-OUI candidate list. The method 300 proceeds after step 340 or 350 to step 360. At step 360, the UE decides whether other beacon information, such as Base Station System (BSS) load, can be used to further arrange the order of OUIs. If this is true, then at step 370 the UE uses this information to further arrange the order in the OUI/non-OUI candidate list.

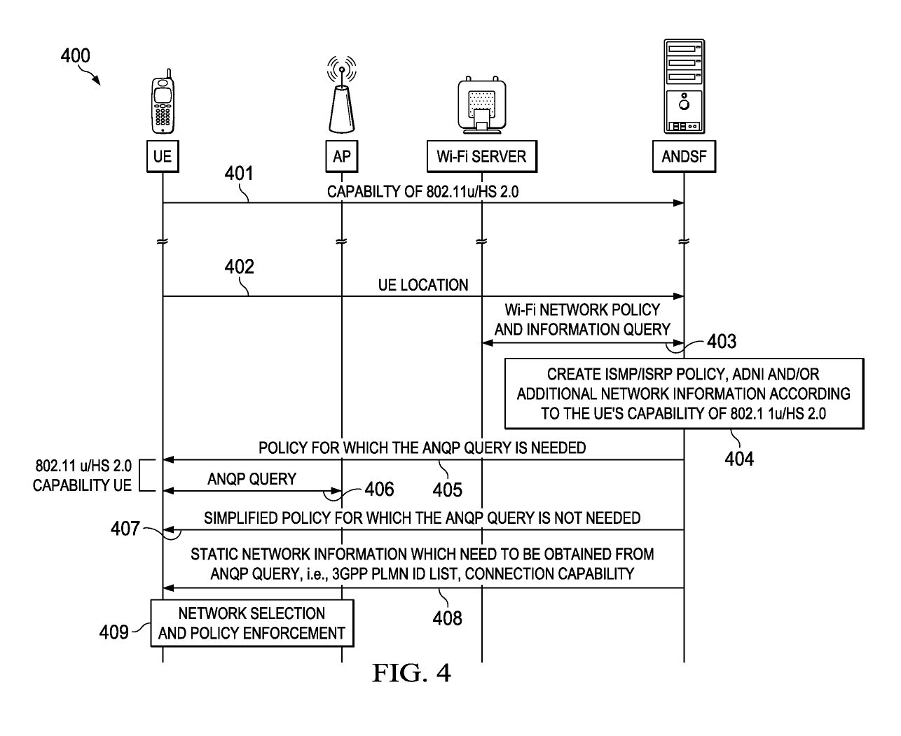

FIG. 4 illustrates an embodiment scheme 400 for obtaining network selection policy and discovery information based on UE capability for HS2.0 devices via an ANDSF. At step 401, a UE sends its capability information of 802.11u and/or HS2.0 to an ANDSF in a network (e.g., a 3GPP core). The UE can access the ANDSF via an AP and a WiFi server (e.g., in a WLAN). At step 402, the UE informs the ANDSF of its location. At step 403, the ANDSF queries the WiFi server to request WiFi network policy and discovery information. At step 404, the ANDSF creates Inter-System Mobility Policy (ISMP)/Inter System Routing Policy (ISRP) policy, ADNI and/or additional network information according to the UE's capability of 801.11u/HS2.0. At step 405, the ANDSF may indicate to the UE (via WiFi server and AP) network selection policy and discovery information of which ANQP query is needed according to the UE 802.11u/HS2.0 capability. To request the indicated policy/discovery information, at step 506, the UE sends the ANQP query to the AP of the WLAN. At step 407, the ANDS sends the UE simplified network selection policy information for which ANQP query is not needed. At step 408, the ANDSF sends the UE static network information which needs to be obtained from ANQP query, e.g., a 3GPP PLMN ID list and connection capability. At step 409, the UE communicates with the AP for network selection and policy enforcement. In various embodiments, it can be understood that, the ANDSF may send the network selection policy and discovery information and the simplified network selection policy information in a same message, or in different messages as shown as in steps 405 and 407.

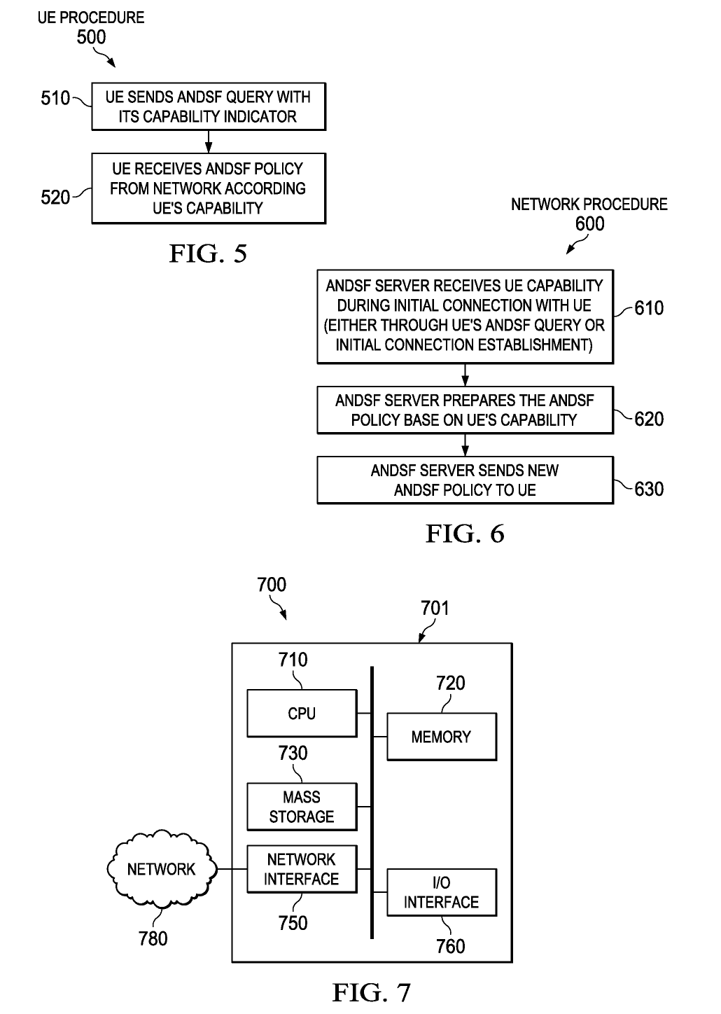

FIG. 5 illustrates an embodiment method 500 implemented by a UE for enabling network selection for HS2.0 devices. At step 510, the UE sends to an ANDSF server ANDSF query with UE capability indication. At step 520, the UE receives, from the ANDSF server or network, ANDSF policy and network discovery information indicating available WLANs for the UE, according to the UE's capability. FIG. 6 illustrates a corresponding embodiment method 600 implemented by the network or ANDSF server for enabling the network selection for HS2.0 UE. At step 610, The ANDSF server receives the UE capability during initial connection with the UE, e.g., either through the UE's ANDSF query or initial connection establishment. At step 620, the ANDSF server prepares the ANDSF policy and network discovery information based on UE's capability. At step 630, the ANDSF server sends new ANDSF policy/discovery information to the UE. With knowledge of capability of UE if needed (e.g., if the UE does not support HS2.0), the ANDSF server can better provision the policy/discovery information accordingly to save network resource.

In an alternative embodiment, the ANDSF server prepares different network selection policy and network discovery information indicating available wireless networks for the UE for both UEs supporting HS2.0 and UEs lacking support of HS2.0. The ANDSF server then sends both groups of information to a UE, allowing the UE to select the group according to the UE's own capability (e.g.,support or lack of support for HS2.0).

In an embodiment, network selection trigger policies and corresponding procedures are included to determine in which conditions the network selection policy can be used. For instance, validity area and time of day information are used as trigger information. The parameters validity_area and time_of_day define respectively the geographic and time condition for the policy rules, which can be interpreted in what condition the rules can be applied. The definition or usage of these parameters can also be extended for when and where the policy can be triggered. A new trigger policy set can be created in ISMR, ISRP and network discovery, which includes trigger policy, such as geographic trigger, time trigger, load threshold trigger, and/or any other suitable triggers. An APP container or Application Programming Interface (API) may also be created within ANDSF to enable APP triggered network discovery and selection for supporting APP trigger and control.

FIG. 7 is a block diagram of an exemplary processing system 700 that can be used to implement various embodiments. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 700 may comprise a processing unit 701 equipped with one or more input/output devices, such as a network interfaces, storage interfaces, and the like. The processing unit 701 may include a central processing unit (CPU) 710, a memory 720, a mass storage device 730, and an I/O interface 760 connected to a bus. The bus may be one or more of any type of several bus architectures including a memory bus or memory controller, a peripheral bus or the like.

The CPU 710 may comprise any type of electronic data processor. The memory 720 may comprise any type of system memory such as static random access memory (SRAM), dynamic random access memory (DRAM), synchronous DRAM (SDRAM), read-only memory (ROM), a combination thereof, or the like. In an embodiment, the memory 720 may include ROM for use at boot-up, and DRAM for program and data storage for use while executing programs. In embodiments, the memory 720 is non-transitory. The mass storage device 730 may comprise any type of storage device configured to store data, programs, and other information and to make the data, programs, and other information accessible via the bus. The mass storage device 730 may comprise, for example, one or more of a solid state drive, hard disk drive, a magnetic disk drive, an optical disk drive, or the like.

The processing unit 701 also includes one or more network interfaces 750, which may comprise wired links, such as an Ethernet cable or the like, and/or wireless links to access nodes or one or more networks 780. The network interface 750 allows the processing unit 701 to communicate with remote units via the networks 780. For example, the network interface 750 may provide wireless communication via one or more transmitters/transmit antennas and one or more receivers/receive antennas. In an embodiment, the processing unit 701 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a network component for enabling user equipment (UE) network selection, the method comprising:
receiving, at an Access Network Discovery and Selection Function (ANDSF), an ANDSF query from a UE, the ANDSAF query including capability information regarding network selection and network access technology for the UE;
generating, at the ANDSF, network selection policy and network discovery information in accordance with the capability information, the network discovery information indicating available wireless networks for the UE; and
sending, to the UE, the network discovery information indicating available wireless networks for the UE, and upon determining that the UE does not support the defined network selection mechanism, additional network selection policy or network discovery information.

2. The method of claim 1 further comprising prompting the UE to obtain the additional network selection policy or network discovery information via a second network selection function upon determining, according to the capability information, that the UE supports the defined network selection mechanism.

3. The method of claim 2, wherein the defined network selection mechanism is a Hotspot 2.0 WiFi selection mechanism, and wherein the second network selection function is an Access Network Query Protocol (ANQP) query.

4. The method of claim 1 further comprising:
further receiving from the UE a second ANDSF query after sending the network selection policy and network discovery information; and
sending additional network discovery information to the UE upon receiving the ANDSF query.

5. The method of claim 4, wherein the additional network discovery information include at least one of a domain name list, connection capability, venue name information, operating class indication, and a list of Organizationally Unique Identifiers (OUIs) corresponding to the available wireless networks.

6. The method of claim 1, wherein the capability information is received upon establishing an initial connection with the UE.

7. The method of claim 1 further comprising receiving an ANDSF query from the UE before or upon receiving the capability information from the UE.

8. A method implemented by a network component for enabling user equipment (UE) network selection, the method comprising:
generating, using an Access Network Discovery and Selection Function (ANDSF), network selection policy and network discovery information indicating available wireless networks for UEs with capability to support a defined network selection mechanism;
generating, using the ANDSF, additional network selection policy and network discovery information for UEs without capability to support the defined network selection mechanism; and
sending, to a UE, both the network selection policy and network discovery information for UEs with capability to support a defined network selection mechanism, and the additional network selection policy and network discovery information for UEs without capability to support the defined network selection mechanism.

9. The method of claim 8, wherein the defined network selection mechanism is a Hotspot 2.0 WiFi selection mechanism.

10. A method implemented by a user equipment (UE) for network selection, the method comprising:
sending, to an Access Network Discovery and Selection Function (ANDSF) server, an ANDSF query indicating UE capability information regarding network selection and network access technology for the UE;
receiving, from the ANDSF server, network selection policy and network discovery information indicating available wireless local area networks (WLANs) for the UE in accordance with the capability information from the UE; and
sending, to a WLAN, an Access Network Query Protocol (ANQP) query for additional network selection policy upon determining that the UE supports the defined network selection mechanism.

11. The method of claim 10, wherein the defined network selection mechanism is a Hotspot 2.0 WiFi network selection mechanism.

12. The method of claim 10 further comprising obtaining the additional network selection policy from the ANDSF server upon determining that the UE does not support the defined network selection mechanism.

13. The method of claim 12, wherein the additional network selection policy is obtained from the ANDSF server in accordance with an IEEE 802.11 standard.

14. The method of claim 10 further comprising:
detecting beacon information from a neighbor access point (AP), the beacon information including an Organizationally Unique Identifier (OUI) assigned to a wireless local area network (WLAN) of the OUI;
determining whether the OUI belongs to an OUI prefer list obtained in the network discovery information from the ANDSF server; and
upon determining that the OUI belongs to the OUI prefer list, adding in order the OUI to a candidate AP list.

15. A method implemented by a user equipment (UE) for network selection, the method comprising:
receiving, from the ANDSF server, network selection policy and network discovery information indicating available wireless networks for UEs with capability to support a defined network selection mechanism;
further receiving, from the ANDSF server, additional network selection policy and network discovery information for UEs without capability to support the defined network selection mechanism; and
selecting a wireless access network using the network selection policy and network discovery information for UEs with capability to support a defined network selection mechanism upon determining that the UE supports the defined network selection mechanism, or using the additional network selection policy and network discovery information for UEs without capability to support the defined network selection mechanism upon determining that the UE does not support the defined network selection mechanism.

16. The method of claim 15, wherein selecting a wireless access network using the network selection policy and network discovery information for UEs with capability to support a defined network selection mechanism includes sending, to the wireless access network, an Access Network Query Protocol (ANQP) query for additional network selection policy.

17. The method of claim 15, wherein the defined network selection mechanism is a Hotspot 2.0 WiFi network selection mechanism.

18. A network component for enabling user equipment (UE) network selection, the network component comprising:
at least one processor; and
a non-transitory computer readable storage medium storing programming for execution by the at least one processor, the programming including instructions to:
receive, at an Access Network Discovery and Selection Function (ANDSF), an ANDSF query from a UE, the ANDSAF query including capability information regarding network selection and network access technology for the UE;
generate, at the ANDSF, network selection policy and network discovery information in accordance with the capability information, the network discovery information indicating available wireless networks for the UE; and
send, to the UE, the network discovery information indicating available wireless networks for the UE, and upon determining that the UE does not support the defined network selection mechanism, additional network selection policy or network discovery information.

19. The network component of claim 18, wherein the defined network selection mechanism is a Hotspot 2.0 WiFi selection mechanism.

20. A network component for enabling user equipment (UE) network selection, the network component comprising:
at least one processor; and
a non-transitory computer readable storage medium storing programming for execution by the at least one processor, the programming including instructions to:
generate, using an Access Network Discovery and Selection Function (ANDSF), network selection policy and network discovery information indicating available wireless networks for UEs with capability to support a defined network selection mechanism;
generate, using the ANDSF, additional network selection policy and network discovery information for UEs without capability to support the defined network selection mechanism; and
send, to a UE, both the network selection policy and network discovery information for UEs with capability to support a defined network selection mechanism, and the additional network selection policy and network discovery information for UEs without capability to support the defined network selection mechanism.

21. The network component of claim 20, wherein the defined network selection mechanism is a Hotspot 2.0 WiFi selection mechanism.

22. A user equipment (UE) configured for network selection for wireless network access, the UE comprising:
at least one processor; and
a non-transitory computer readable storage medium storing programming for execution by the at least one processor, the programming including instructions to:
send, to an Access Network Discovery and Selection Function (ANDSF) server, an ANDSF query indicating UE capability information regarding network selection and network access technology for the UE;
receive, from the ANDSF server, network selection policy and network discovery information indicating available wireless local area networks (WLANs) for the UE in accordance with the capability information from the UE; and
send, to a WLAN, an Access Network Query Protocol (ANQP) query for additional network selection policy upon determining that the UE supports the defined network selection mechanism.

23. The UE of claim 22, wherein the defined network selection mechanism is a Hotspot 2.0 WiFi selection mechanism.

24. A user equipment (UE) configured for network selection for wireless network access, the UE comprising:
at least one processor; and
a non-transitory computer readable storage medium storing programming for execution by the at least one processor, the programming including instructions to:
receive, from the ANDSF server, network selection policy and network discovery information indicating available wireless networks for UEs with capability to support a defined network selection mechanism;
further receive, from the ANDSF server, additional network selection policy and network discovery information for UEs without capability to support the defined network selection mechanism; and
select a wireless access network using the network selection policy and network discovery information for UEs with capability to support a defined network selection mechanism upon determining that the UE supports the defined network selection mechanism, or using the additional network selection policy and network discovery information for UEs without capability to support the defined network selection mechanism upon determining that the UE does not support the defined network selection mechanism.

25. The UE of claim 24, wherein the defined network selection mechanism is a Hotspot 2.0 WiFi selection mechanism.
